(19) United States
(12) Patent Application Publication
(10) Pub. No.: US 2017/0270097 A1
(43) Pub. Date: Sep. 21, 2017

(54) DETERMINATION APPARATUS AND DETERMINATION METHOD

(71) Applicant: YAHOO JAPAN CORPORATION, Tokyo (JP)

(72) Inventors: Hayato KOBAYASHI, Tokyo (JP); Takashi MIYAZAKI, Tokyo (JP); Yuusuke WATANABE, Tokyo (JP)

(73) Assignee: YAHOO JAPAN CORPORATION, Tokyo (JP)

(21) Appl. No.: 15/453,317

(22) Filed: Mar. 8, 2017

(30) Foreign Application Priority Data
Mar. 17, 2016 (JP) 2016-054543

(51) Int. Cl. G06F 17/27

(52) U.S. Cl. CPC G06F 17/2775; G06F 17/2755

(57) ABSTRACT

According to one aspect of an embodiment a determination apparatus includes an association unit that associates three words between which association is to be determined, on a distributed representation space. The determination apparatus includes a determination unit that determines association between the three words as an angle defined by the three words associated with each other on the distributed representation space.

### CROSS-REFERENCE TO RELATED APPLICATIONS

The present application claims priority to and incorporates by reference the entire contents of Japanese Patent Application No. 2016-054543 filed in Japan on Mar. 17, 2016.

### BACKGROUND OF THE INVENTION

1. Field of the Invention

The present invention relates to a determination apparatus and a determination method.

2. Description of the Related Art

A technique is known in which, on the basis of an analysis result of input information, information relating to the input information is detected or generated, and the detected or generated information is output as a response. As an example of such a technique, a natural language processing technique is known in which words, sentences, and contexts included in an input text are analyzed by being converted to multi-dimensional vectors, a text similar to the input text or a text subsequent to the input text is analogized on the basis of a result of the analysis, and an analogical result is output.

Japanese Patent Application Laid-open No. 2015-170168

Non-Patent Literature 1: “Molecular Dynamics Simulation of Biological Molecules (1) Methods” Yuto KOMEIJI, Masami UEBAYASI and Umpei NAGASHIMA, J. Chem. Software, Vol. 6, No. 1, p. 1-36 (2000), Internet <http://www.sccj.net/CSSJ/jcs/v6n1/a1/document.pdf> (retrieved on Feb. 29, 2016)

However, in the related art, association between two words is only used to convert the text to the multi-dimensional vectors, or analogize the text similar to the input text, and a method using association between three or more words has not been proposed.

### SUMMARY OF THE INVENTION

It is an object of the present invention to at least partially solve the problems in the conventional technology.

According to one aspect of an embodiment a determination apparatus includes an association unit that associates three words between which association is to be determined, on a distributed representation space. The determination apparatus includes a determination unit that determines association between the three words as an angle defined by the three words associated with each other on the distributed representation space.

According to one aspect of an embodiment a determination apparatus includes an association unit that associates four words between which association is to be determined, on a distributed representation space. The determination apparatus includes a determination unit that determines association between the four words as a dihedral angle defined by the four words associated with each other on the distributed representation space.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an exemplary determination process according to an embodiment;

FIG. 2 is a diagram illustrating an exemplary functional configuration of a determination apparatus according to an embodiment;

FIG. 3 is a table illustrating an example of information registered in a word database according to an embodiment;

FIG. 4 is a flowchart illustrating an example of a process performed by a determination apparatus according to an embodiment; and

FIG. 5 is a diagram illustrating an exemplary hardware configuration.

### DETAILED DESCRIPTION OF THE PREFERRED EMBODIMENTS

Modes for carrying out a determination apparatus, and a determination method according to the present application (hereinafter, described as “embodiment”) will be described in detail below with reference to the drawings. Note that the determination apparatus, and the determination method according to the present application are not limited to the embodiments. Furthermore, in the following embodiments, the same portions are denoted by the same reference signs, and repetitive description thereof will be omitted.

1. Determination apparatus

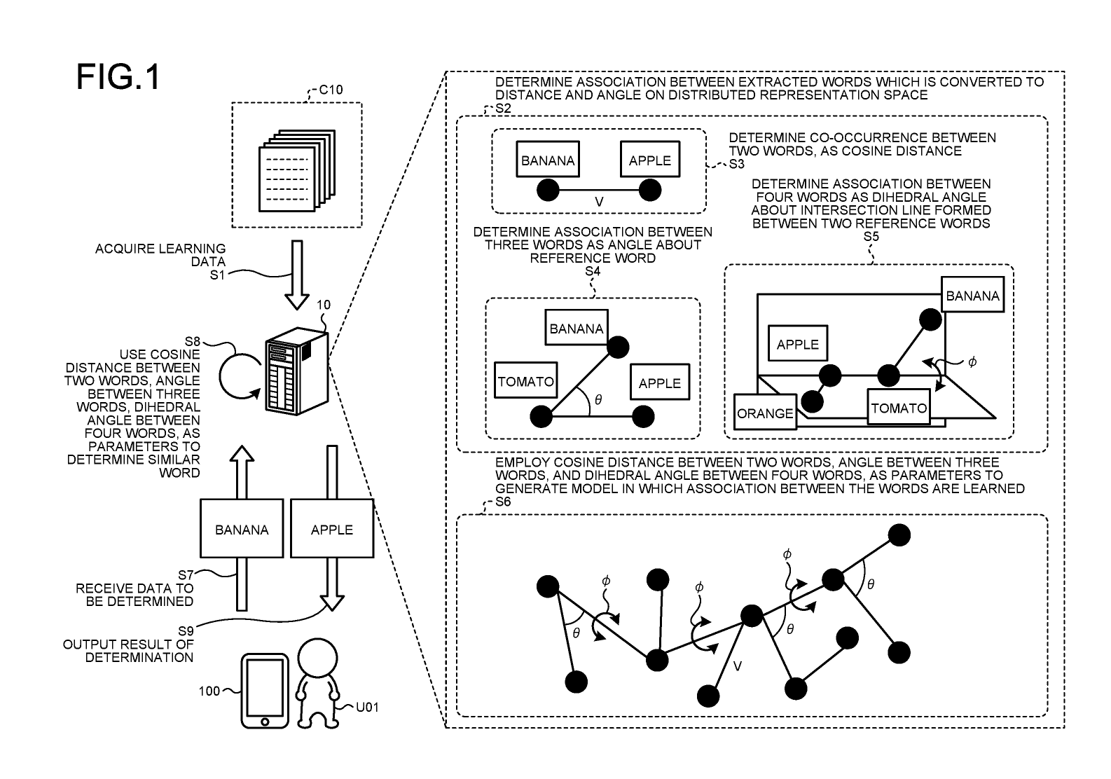

First, with reference to FIG. 1, an exemplary determination process according to an embodiment will be described. FIG. 1 is a diagram illustrating the exemplary determination process according to an embodiment. In FIG. 1, the exemplary determination process will be described which uses predetermined learning data C10 to determine semantic association between words (hereinafter, sometimes referred to as “association between words”). Furthermore, exemplary processes of learning the association between words on the basis of a result of the determination process, and outputting a word similar to an input word on the basis of a result of the learning will be described, in the following description.

A determination apparatus 10 is an apparatus determining association between words, and performing a learning process and an output process based on a result of the determination. For example, the determination apparatus 10 includes a server device, a cloud system, or the like. Such a determination apparatus 10 performs the determination process of determining association between words, the learning process of learning the association between the words on the basis of a result of the determination process, and the output process of outputting a word or the like similar to an input word, on the basis of a result of the determination.

1-1. Determination process and learning process

Here, as a method of determining association between words, a technique, such as word to vector (w2v), is known which converts words to be determined to multi-dimensional numerical values, that is, distributed representations, maps the distributed representation after conversion on a distributed representation space, and determines association between the words. For example, in a related art using such distributed representations, words are extracted from the learning data C10, the extracted words are mapped on the distributed representation space, a cosine distance (also referred to as inner product or cosine similarity) between the words on the distributed representation space is adjusted, according to an appearance frequency of each word, a relationship between the words in the learning data C10, or the like, and the association between the words is learned. Then, in the related art, it is determined whether the words are similar to each other, on the basis of the final cosine distance between the words or the like. That is, in the related art, the association between the words is determined on the basis of the cosine distance between the words.

However, when it is determined whether the words are similar to each other, on the basis of the cosine distance between words, similarity between two words can be determined, but determination cannot be made on the basis of association between three words. That is, in the related art, the association between two words is merely determined, and association between three or more words cannot be accurately determined. For example, in the related art, when association between a word #1, a word #2, and a word #3 is determined, association between the word #1 and the word #2, and association between the word #2 and the word #3 are merely determined, and whole association between the three words, such as a relationship between the word #2 and the word #3 about the word #1, cannot be determined. Accordingly, in the related art, the association between three or more words cannot be reflected on the distributed representation space, and learning accuracy cannot be improved.

Thus, the determination apparatus 10 performs the following determination process. First, the determination apparatus 10 acquires writing such as a novel or patent specification, as the learning data C10 (step S1). In such a case, the determination apparatus 10 performs morphological analysis of a text included in the learning data C10, and extract words to be determined. For example, the determination apparatus 10 extracts nouns included in the learning data C10. Furthermore, the determination apparatus 10 determines association between the extracted words which is converted to a distance and an angle on the distributed representation space (step S2). Then, the determination apparatus 10 employs a cosine distance between two words, an angle between three words, and a dihedral angle between four words, as parameters, and performs the learning process of generating a model in which association between the words are learned. That is, the determination apparatus 10 causes a learner for determining association between words to perform learning, on the basis of a result of the determination process in step S2.

For example, the determination apparatus 10 determines co-occurrence between two words, as the cosine distance (step S3). Specifically, the determination apparatus 10 converts a word “banana” and a word “apple” to the distributed representations. Then, in the learning data C10, the determination apparatus 10 adjusts the cosine distance between a distributed representation of the word “banana” and a distributed representation of the word “apple”, on the basis of an appearance frequency between the word “banana” and the word “apple”, an appearance distance between the word “banana” and the word “apple”, or the like. That is, the determination apparatus 10 learns association between two words, with the cosine distance on the distributed representation space, as a parameter.

Furthermore, the determination apparatus 10 determines association between three words as an angle about a reference word (step S4). Specifically, the determination apparatus 10 determines the association between three words as the angle defined by the three words mapped on the distributed representation space. For example, the determination apparatus 10 selects one word from the three words, as the reference word. Furthermore, the determination apparatus 10 calculates an angle between the other two words about the reference word (vertex), on the distributed representation space. For example, when determining association between “banana”, “tomato”, and “apple”, the determination apparatus 10 determines an angle θ between “banana” and “apple” about “tomato” as the vertex, on the distributed representation space, as information representing association between “banana”, “tomato”, and “apple”. Then, the determination apparatus 10 adjusts the calculated angle θ, according to appearance frequency, distance, or the like between the three words in the learning data C10. That is, the determination apparatus 10 learns the association between the three words, with the angle θ generated between three words on the distributed representation space, as a parameter.

Furthermore, the determination apparatus 10 determines association between four words as a dihedral angle about an intersection line formed between two reference words (step S5). Specifically, the determination apparatus 10 determines association between four words, as the dihedral angle defined by the four words mapped on the distributed representation space. For example, the determination apparatus 10 selects two words from the four words, as the reference words. Then, the determination apparatus 10 calculates an angle φ between two planes having a line including the selected two reference words, as an intersection line, and respectively including different words other than the reference words. For example, when determining association between “banana”, “tomato”, “apple”, and “orange”, the determination apparatus 10 selects “apple” and “tomato”, as the reference words. Note that the determination apparatus 10 preferably selects an arbitrary word, as the reference word. Then, the determination apparatus 10 determines the angle φ between a plane including “apple” and “tomato” as the reference words, and “banana”, and a plane including “apple” and “tomato” as the reference words, and “orange”, as information representing the association between “banana”, “tomato”, “apple”, and “orange”. Thereafter, the determination apparatus 10 adjusts the calculated angle φ, according to an appearance frequency, distance, or the like between the four words in the learning data C10. That is, the determination apparatus 10 learns the association between the four words, with the angle φ generated between four words on the distributed representation space, as a parameter.

As described above, the determination apparatus 10 generates a set of two words, a set of three words, and a set of four words, from the words extracted from the learning data C10, and calculates, as the parameters, the cosine distance between the two words, the angle between the three words, and the dihedral angle between the four words, for each of the generated sets. Then, the determination apparatus 10 adjusts the calculated parameters, as the association between the two words, the association between the three words, and the association between the four words, on the basis of the learning data C10, and generates the learner having learned the association between the words (step S6).

Note that the determination apparatus 10 may generate a learner of an arbitrary mode, as the learner having learned the association between the words. For example, the determination apparatus 10 uses for example a neural network having a plurality of intermediate layers (using a technique so called deep learning) to learn the association between words. Note that the determination apparatus 10 may cause a learner learning w2v to learn the cosine distance between two words, the angle between three words, and the dihedral angle between four words, as the parameters.

Note that, for example, the determination apparatus 10 may learn the dihedral angle between four words as the parameter, and learn the angle between three words included in the four words, as the parameter. Furthermore, the determination apparatus 10 may determine the angle and the dihedral angle between overlapping words. For example, the determination apparatus 10 may employ, as the parameters, an angle between “tomato” and “apple” about “banana” as the vertex, and an angle between “banana” and “apple” about “tomato” as the vertex. Furthermore, for example, the determination apparatus 10 may calculate an angle between a plane including “apple”, “tomato”, and “banana”, and a plane including “apple”, “tomato”, and “orange”, and calculate an angle between a plane including “orange”, “tomato”, and “banana”, and a plane including “orange”, “tomato”, and “apple” to employ both of the angles as the parameters. That is, the determination apparatus 10 may learn an appropriate combination of the processes described above.

1-2. Output Process

Next, the output process performed by the determination apparatus 10 on the basis of a result of the determination will be described. First, the determination apparatus 10 receives data to be determined, from a terminal device 100 used by a user U01 (step S7). For example, the determination apparatus 10 receives a word “banana” as the data to be determined. In this situation, the determination apparatus 10 uses as the parameters the cosine distance between the two words, the angle between the three words, and the dihedral angle between the four words, which have been learned, to determine a word similar to the word “banana” as the data to be determined. That is, the determination apparatus 10 uses the cosine distance between the two words, the angle between the three words, the dihedral angle between the four words, as the parameters to determine the word similar to the word “banana”, using the distributed representation space on which the words are mapped (step S8). For example, the determination apparatus 10 extracts a word closer to “banana” in cosine distance, or another word closer to “banana” in angle. Then, the determination apparatus 10 outputs a result of the determination to the terminal device 100 (step S9). For example, when the word similar to the word “banana” is “apple”, on the distributed representation space, the determination apparatus 10 outputs the word “apple” to the terminal device 100.

Note that the determination apparatus 10 may perform an arbitrary process as the output process, as long as the arbitrary process is based on a result of the determination. For example, when receiving three words as sets of data to be determined from the terminal device 100, the determination apparatus 10 calculates the angle θ defined between the three words, received as the sets of data to be determined, on the distributed representation space. Then, on the basis of a value of the calculated angle θ, the determination apparatus 10 may output information representing whether the three words received as the sets of data to be determined have association with each other, what kind of association the three words have, or the like, as a result of the determination. Similarly, when receiving four words as the sets of data to be determined from the terminal device 100, the determination apparatus 10 calculates the dihedral angle φ defined between the four words, received as the sets of data to be determined, on the distributed representation space. Then, on the basis of a value of the calculated dihedral angle φ, the determination apparatus 10 may output information representing whether the four words received as sets of data to be determined have association with each other, what kind of association the four words have, or the like, as a result of the determination.

2. Configuration of Determination Apparatus

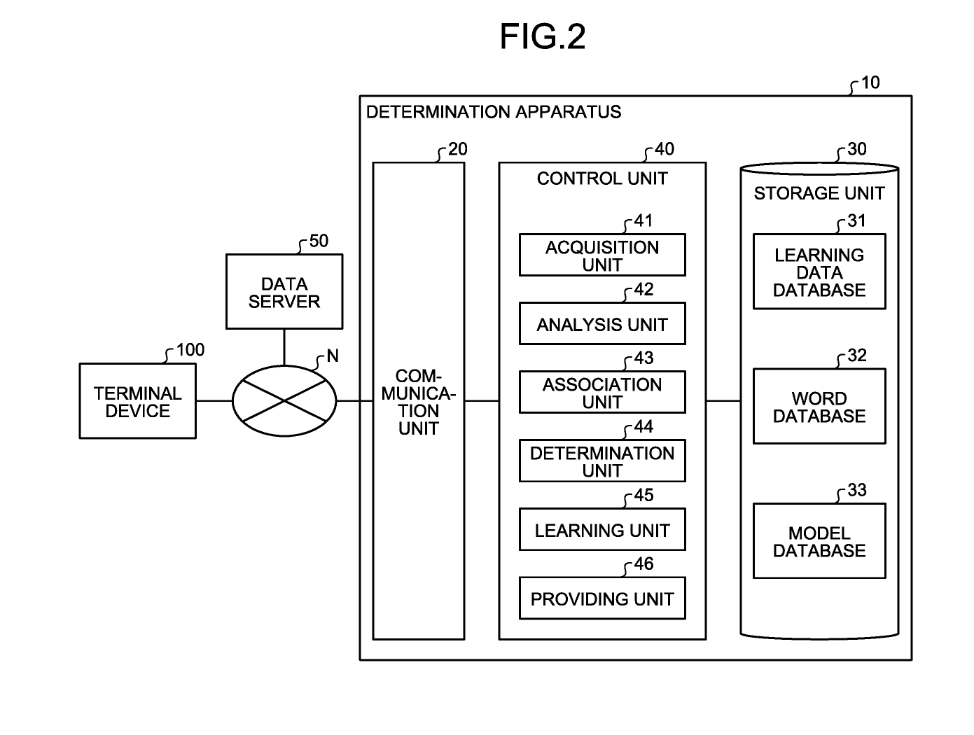

Next, a configuration of the determination apparatus 10 according to the embodiment described above will be described. FIG. 2 is a diagram illustrating an exemplary functional configuration of the determination apparatus according to an embodiment. As illustrated in FIG. 2, the determination apparatus 10 has a communication unit 20, a storage unit 30, and a control unit 40. The communication unit 20 includes for example a network interface card (NIC). The communication unit 20 is connected to a network N via wired or wireless connection, and transmits and receives information to and from the terminal device 100 or a data server 50. Note that the data server 50 is an information processor distributing arbitrary text data usable as the learning data C10, such as various novels or items including news, or a treatise database or patent specification database, and includes a server device, a cloud system, or the like.

The storage unit 30 includes for example, a random access memory (RAM), a semiconductor memory device such as a flash memory, or a storage device such as a hard disk or an optical disk. Furthermore, the storage unit 30 has a learning data database 31, a word database 32, and a model database 33 (hereinafter, sometimes referred to as “databases 31 to 33”).

In the learning data database 31, the learning data C10 is registered. For example, text data such as a novel, a news item, a treatise, a patent specification acquired as the learning data from the data server 50, is stored in the learning data database 31.

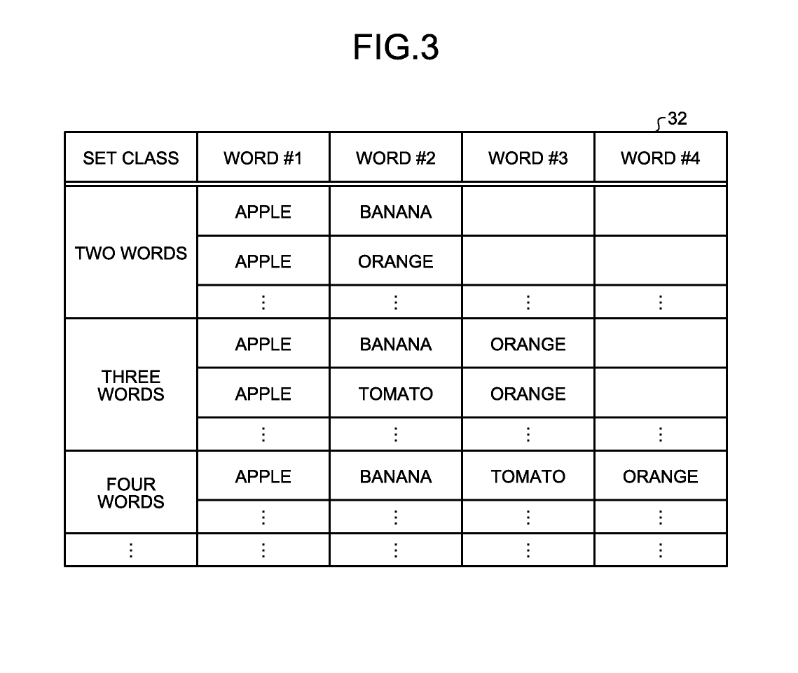

In the word database 32, words extracted from the learning data C10 registered in the learning data database 31 are registered. For example, FIG. 3 is a table illustrating an example of information registered in the word database according to an embodiment. For example, in the example illustrated in FIG. 3, sets of information having items such as “set class”, “word #1” to “word #4” is registered in the word database 32.

Here, “set class” is information representing the number of associated words. For example, in the word database 32, sets of information associating two different words with each other are registered in association with each other for a set class “two words”, and sets of information associating three different words with each other are registered in association with each other for a set class “three words”. Furthermore, in the word database 32, sets of information associating four different words with each other are registered in association with each other for a set class “four words”. Note that in FIG. 3, the example of registration of words such as “apple” or “banana”, as the words extracted from the learning data C10, is illustrated, but embodiments are not limited thereto. That is, in the word database 32, arbitrary words extracted from the learning data C10 are registered.

Returning to FIG. 2, the description is continued. In the model database 33, data of a model, which is learned on the basis of a determination result being a result of the determination process, is registered. For example, a model in which words included in the learning data C10 are mapped on the distributed representation space, on the basis of relationships between the words, that is, a model used for w2v process or the like is registered, in the model database 33. Note that in the model database 33, data of the neural network having a plurality of intermediate layers, used for so-called deep learning or the like, may be registered.

The control unit 40 is a controller, and is achieved for example through execution of various programs stored in a storage device in the determination apparatus 10 by a processor such as a central processing unit (CPU) or a micro processing unit (MPU), using a RAM or the like as a work area. Furthermore, the control unit 40 is a controller, and may be achieved by for example an integrated circuit such as an application specific integrated circuit (ASIC) or a field programmable gate array (FPGA).

As illustrated in FIG. 2, the control unit 40 has an acquisition unit 41, an analysis unit 42, an association unit 43, a determination unit 44, a learning unit 45, and a providing unit 46 to achieve or perform a function or operation of information processing described below. Note that an internal configuration of the control unit 40 is not limited to the configuration illustrated in FIG. 2, and the control unit 40 may employ another configuration, as long as the configuration performs information processing described later.

The acquisition unit 41 acquires the learning data C10 including words to be determined. For example, the acquisition unit 41 acquires the learning data C10 from the data server 50 or the like. Then, the acquisition unit 41 registers the acquired learning data C10 in the learning data database 31. Note that the acquisition unit 41 may collect, as the learning data C10, for example arbitrary texts on a web, in addition to the data server 50, and register the collected learning data C10 in the learning data database 31. Furthermore, the acquisition unit 41 may acquire the learning data C10 including learning text data, from the terminal device 100 or the like used by the user U01, and register the acquired learning data C10 in the learning data database 31.

The analysis unit 42 analyzes the learning data C10 registered in the learning data database 31, and extracts words to be determined, that is, words to be learned. For example, after reading the learning data C10 from the learning data database 31, the analysis unit 42 performs the morphological analysis of the learning data C10. Then, the analysis unit 42 extracts words to be determined from the learning data C10.

Furthermore, the analysis unit 42 generates a set of two words (hereinafter, described as “two words”), a set of three words (hereinafter, described as “three words”), and a set of four words (hereinafter, described as “four words”), from the extracted words. For example, the analysis unit 42 combines the extracted words in a round robin manner to generate the two words, the three words, and the four words, and registers the generated two words, three words, and four words in the word database 32.

The association unit 43 associates the two words, the three words, and the four words between which association is to be determined, on the distributed representation space. Furthermore, the determination unit 44 determines association between the words, as the cosine distance, the angle defined by the three words, and the dihedral angle defined by the four words, on the distributed representation space. Then, on the basis of a result of the determination by the determination unit 44, the learning unit 45 generates a model for learning association between the plurality of words, and registers the generated model in the model database 33.

For example, the association unit 43 converts the words registered in the word database 32 to the distributed representations. Then, the determination unit 44 performs the following processing for the respective two words registered in the word database 32. First, the determination unit 44 calculates the cosine distance of the two words to be determined on the distributed representation space, as the parameter of the association between the two words. Furthermore, the determination unit 44 refers to the learning data C10 registered in the learning data database 31 to acquire an appearance frequency of the two words to be determined, identity in appearing context, an appearance distance between the two words in the learning data C10, and the like, as indices of the association between the two words. Then, the learning unit 45 employs, as the parameter, the cosine distance calculated by the determination unit 44, as the parameter of the association between the two words, and adjusts the distributed representations of the two words to be determined, according to the indices acquired from the learning data C10 by the determination unit 44. For example, when the two words to be determined are words similar to each other in the learning data C10, the learning unit 45 adjusts the distributed representations of the two words so that the cosine distance has a larger value.

That is, the determination unit 44 determines the association between the two words as the cosine distance on the distributed representation space. Then, the learning unit 45 learns the distributed representations between the two words to be determined, on the basis of a result of the determination. Performance of such adjustment for respective two words registered in the word database 32, allows the determination apparatus 10 to acquire the distributed representations of the respective words in which association between the respective two words is converted to the cosine distance. Note that a known technique such as w2v can be applied to such a learning method using the cosine distance.

Furthermore, the determination unit 44 converts the association between the three words and the association between the four words to the angle and the dihedral angle on the distributed representation space, and acquires distributed representations including more accurate association between the words. For example, the determination unit 44 calculates the angle on the distributed representation space defined by the three words to be determined, as the parameter of the association between the three words. More specifically, the determination unit 44 selects one word from the three words to be determined, as the reference word, and calculates the angle, on the distributed representation space, between the other two words about the reference word as the vertex. Furthermore, the determination unit 44 refers to the learning data C10 registered in the learning data database 31 to acquire the appearance frequency of the three words to be determined, the identity in appearing context, and the appearance distance between the three words in the learning data C10, and the like, as the indices of the association between the three words. Then, the learning unit 45 employs the angle calculated by the determination unit 44, as the parameter of the association between the three words, and adjusts the distributed representations of the three words to be determined, according to the indices acquired from the learning data C10 by the determination unit 44. For example, when the three words to be determined are words similar to each other in the learning data C10, the learning unit 45 adjusts the distributed representations of the three words so that the angle has a smaller value.

Furthermore, for example, the determination unit 44 calculates the dihedral angle on the distributed representation space defined by the four words to be determined, as the parameter of the association between the four words. More specifically, the determination unit 44 selects two words from the four words to be determined, as the reference words. Then, the determination unit 44 calculates the angle between two planes having a line, as the intersection line, including the two words selected as the reference words, and respectively including the words other than the reference words, of the four words to be determined, on the distributed representation space. That is, when a word #1 and a word#2 are selected as the reference words from words #1 to#4 included in the four words, the determination unit 44 calculates the angle, that is, the dihedral angle, between a plane including the words #1 to#3 on the distributed representation space, and a plane including the word#1, the word #2, and the word#4 on the distributed representation space.

Furthermore, the determination unit 44 acquires indices of the association between the four words, such as the appearance frequency of the four words to be determined in the learning data C10, as in the cases of the two words and the three words. Then, the learning unit 45 employs, as the parameter, the dihedral angle calculated by the determination unit 44, as the parameter of the association between the four words, and adjusts the distributed representations of the four words to be determined, according to the indices acquired from the learning data C10 by the determination unit 44. For example, when the four words to be determined are words similar to each other in the learning data C10, the learning unit 45 adjusts the distributed representations of the four words so that the dihedral angle has a smaller value.

Note that, in the above description, independent learning of the association between the two words, the association between the three words, and the association between the four words are respectively described, but embodiments are not be limited thereto. That is, the learning unit 45 preferably uses the cosine distance, as the parameter representing the association between two words, the angle on the distributed representation space, as the parameter representing the association between three words, and the dihedral angle on the distributed representation space, as the parameter representing the association between the four words to adjust the distributed representations of the respective words so that the indices acquired from the learning data C10 are reflected on values of the parameters.

Note that the determination unit 44 may determine the association between three words included in the four words to be determined, as the angle defined by the three words on the distributed representation space. That is, the determination unit 44 may determine association between two words, three words, and four words extracted from the learning data C10 in a round robin manner, as the cosine distance, the angle, and the dihedral angle, respectively.

As described above, the determination unit 44 determines the association between three words, as the angle defined by the three words on the distributed representation space. Furthermore, the determination unit 44 determines the association between four words, as the dihedral angle defined by the four words on the distributed representation space. As described above, the determination apparatus 10 has the association between three words and four words, in addition to the association between two words, as the parameters, and the distributed representation space in which the association between words is further accurately reflected can be obtained.

The providing unit 46 uses the distributed representation space learned using a result of the determination to provide various services for the user U01. For example, when receiving the data to be determined from the terminal device 100, the providing unit 46 reads a model registered in the model database 33, that is, a model learned by the learning unit 45, and uses the read model to generate information provided for the user U01, on the basis of the data to be determined. For example, the learning unit 45 uses a model registered in the model database 33 to select a word similar to the word received as the data to be determined, from the distributed representation space. That is, the providing unit 46 uses the cosine distance between two words, the angle between three words, and the dihedral angle between four words, as the parameters, to select a word similar to a word received as the data to be determined. Then, the providing unit 46 provides the selected word to the user U01.

Note that the data to be determined may be for example a calculation formula for calculation between words, as in the w2v or the like. In such a configuration, the providing unit 46 selects a word most similar to a solution of a calculation formula, and provides the word.

3. Example of Calculation Method

Next, an example of a process of calculating sets of information used as various parameters by the determination apparatus 10 using a mathematical formula will be described. Note that, in the following example, calculation of the association between three words and four words, using numerical formulas to which a simulation technique of molecular dynamics is applied is exemplified, but embodiments are not limited thereto.

First, an example of a process of calculating cosine similarity between two words will be described. For example, when a word #1 is denoted by q, and a word#2 is denoted by d, which are mapped on the distributed representation space, the cosine similarities of the word #1 and the word#2 can be expressed by the following formula (1). Note that on the distributed representation space, q and d are multi-dimensional quantities (that is, vectors). Note that in formula (1), q and d as the vectors are represented by q and d with a superscript arrow.

$$cos ( \vec{q} , \vec{d} ) = \frac{\vec{q} \cdot \vec{d}}{\vert \vec{q} \vert \vert \vec{d} \vert} = \frac{\vec{q}}{\vert \vec{q} \vert} \cdot \frac{\vec{d}}{\vert \vec{d} \vert} \qquad ( 1 )$$

Here, when the word #1 and the word#2 are similar words, a value of the cosine similarity between the word #1 and the word#2 on the distributed representation space is considered to be increased. Thus, the determination apparatus 10 maps the association between words on the distributed representation space, using the value of the cosine similarity expressed by formula (1), as a parameter. For example, the determination apparatus 10 calculates the cosine similarity between the word #1 and the word #2, and the cosine similarity between the word #1 and the word #3. Then, when it is determined that the association between the word #1 and the word#2 is higher than the association between the word #1 and the word #3, in the learning data C10, the determination apparatus 10 adjusts the distributed representations of the respective words #1 to#3 so that a value of the cosine similarity between the word #1 and the word#2 is larger than a value of the cosine similarity between the word #1 and the word #3.

Next, an example of a process of calculating the angle between three words will be described. For example, a distributed representation of the word #1 is denoted by “i” a distributed representation of the word#2 is denoted by “j”, a distributed representation of the word#3 is denoted by “k”, and an angle made by the word #1 and the word#3 about the word#2 is denoted by “θᵢⱼₖ”. In such a configuration, a cosine “cosθᵢⱼₖ” of “θᵢⱼₖ” can be expressed by the following formula (2). Here, in the denominator of the right side of formula (2), bold “rᵢⱼ” represents a vector from “i” to “j”, and bold “rₖⱼ” represents a vector from “k” to “j”. In addition, in the numerator of the right side of formula (2), “rᵢⱼ” represents a norm of the vector from “i” to “j”, and “rⱼₖ” represents a norm of the vector from “j” to “k”.

$$cos {θ}_{ijk} = \frac{{r}_{ij} \cdot {r}_{kj}}{{r}_{ij} {r}_{jk}} \qquad ( 2 )$$

Thus, the determination apparatus 10 can calculate a cosine of “θᵢⱼₖ” expressed by formula (2), and calculate the calculated value by an inverse trigonometric function (arccos).

The determination apparatus 10 uses the inverse trigonometric function to calculate an angle made by the words #1 to#3 on the distributed representation space, on the basis of the value of formula (2). Furthermore, the determination apparatus 10 uses formula (2) to calculate an angle made by the word#1, the word #2, and the word#4 on the distributed representation space. Then, the determination apparatus 10 compares association between the words #1 to#3 in the learning data C10, and association between the word#1, the word #2, and the word#4 in the learning data C10, and when the association between the words #1 to#3 in the learning data C10 is higher, the determination apparatus 10 adjusts the distributed representations of the words #1 to#4 so that the angle between the words #1 to#3 on the distributed representation space is smaller than the angle between the word#1, the word #2, and the word#4 on the distributed representation space.

Next, an example of a process of calculating the dihedral angle between four words will be described. For example, the distributed representation of the word #1 is denoted by “i”, the distributed representation of the word #2 is denoted by “j”, the distributed representation of the word#3 is denoted by “k”, and a distributed representation of the word#4 is denoted by “l”. Here, when the word#2 and the word#3 are selected as the reference words, the dihedral angle “φ” can be expressed as an angle between a plane including “i”, “j”, and “k”, and a plane including “l”, “j”, and “k”.

Here, when a normal of the plane including “i”, “j”, and “k” is denoted by bold “n₁”, and a normal of the plane including “l”, “j”, and “k” is denoted by bold “n₂”, the bold “n₁” and the bold “n₂” are expressed as the following formula (3). Here, the bold “rᵢⱼ” represents the vector from “i” to “j”, the bold “rₖⱼ” represents the vector from “k” to “j”, and bold “rₖₗ” represents the vector from “k” to “l”.

n₁=rᵢⱼ×rₖⱼ,n₂rₖⱼ×rₖᵢ (3)

Thus, when a dihedral angle defined by the words #1 to #4 is denoted by “φ”, a cosine “cos φ” of “φ” can be expressed by the following formula (4). Here, “n₁” and “n₂38 are norms of bold “n₁” and bold “n₂”.

$$cos φ = \frac{{n}_{1} \cdot {n}_{2}}{{n}_{1} {n}_{2}} \qquad ( 4 )$$

Thus, a value of φ within the range of −π<φ≦π can be expressed by formula (5).

φ=sign(rₖⱼ·(n₁×n₂))αcos(cosφ) (5)

Note that, on the basis of a molecular potential calculation method, the determination apparatus 10 may calculate energy between words on the distributed representation space and learn the calculated energy as a parameter. For example, when the cosine distance, the angle, and the dihedral angle between the words are defined by formula (1) to formula (5) described above, energy between the words can be expressed by the following formula. For example, energy between the word#1, the word #2, and the word #3, that is, “V_{1,2,3}^{angle}” can be expressed by the following formula (6).

V_{1,2,3}^{angle}=K_{1,2,3}(θ_{1,2,3}<θ_{1,2,3}^{eq})² (6)

Furthermore, for example, energy between the words #1 to #4, that is, “V_{1,2,3,4}^{dihedral}” can be expressed by the following formula (7).

$${V}_{1 , 2 , 3 , 4}^{dihedral} = {\sum }_{n} \frac{{V}_{n}}{2} [ 1 + cos ( n \cdot {φ}_{1 , 2 , 3 , 4} - γ ) ] \qquad ( 7 )$$

Furthermore, for example, energy between the word #1 and the word #2, that is, “V_{1,2}^{bond}” can be expressed by the following formula (8).

V_{1,2}^{bond} =K_{1,2}(r_{1,2}−r_{1,2}^{eq})² (8)

On the basis of such a molecular potential calculation method, values of energies virtually generated between the words may be introduced as parameters to improve precision in determination of the association between the words.

Note that the determination apparatus 10 may calculate the indices used to adjust the parameters or the distributed representations described above, that is, association between the words in the learning data C10 by an arbitrary method. For example, when determining the association between the words in the learning data C10, the determination apparatus 10 preferably calculates scores representing the association on the basis of for example a technique such as term frequency-inverse document frequency (TF-IDF) to relatively show the association between the words on the basis of the calculated scores. Similarly, the determination apparatus 10 preferably uses the TF-IDF technique to calculate scores representing the association between a plurality of words to relatively show the association between the words, on the basis of the calculated scores.

4. Example of Process

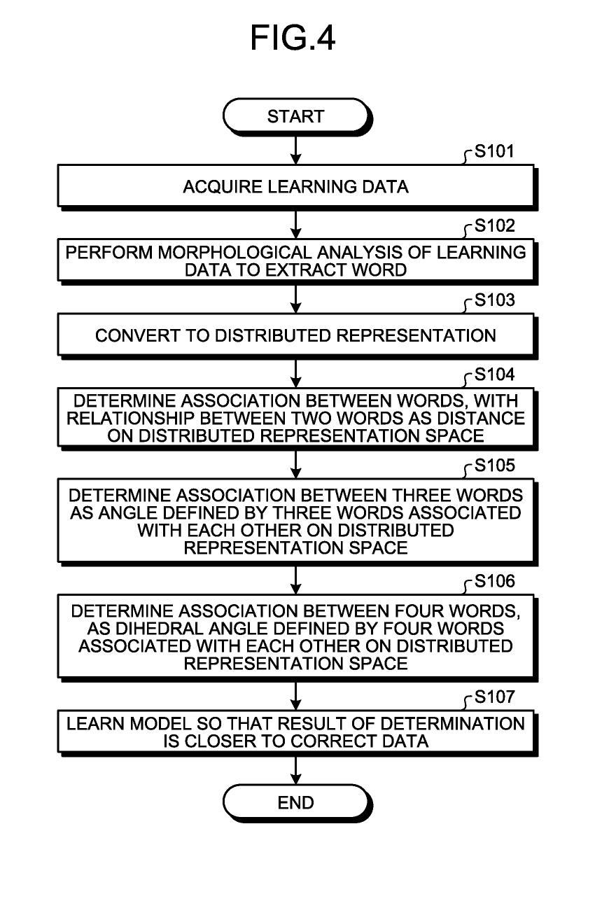

Next, with reference to FIG. 4, an example of a process performed by the determination apparatus 10 will be described. FIG. 4 is a flowchart illustrating an example of the process performed by the determination apparatus according to an embodiment. For example, the determination apparatus 10 acquires learning data C10 (step S101), and performs the morphological analysis of a text included in the learning data C10 to extract words (step S102). Next, the determination apparatus 10 converts the extracted words to the distributed representation (step S103), and determines the association between words, with the association between two words as the distance on the distributed representation space (step S104). Furthermore, the determination apparatus 10 determines association between three words as the angle defined by three words associated with each other on the distributed representation space (step S105). Furthermore, the determination apparatus 10 determines the association between four words, as the dihedral angle defined by the four words associated with each other on the distributed representation space (step S106). Note that the determination apparatus 10 may perform the process of steps S104 to S106 in an arbitrary order or simultaneously in a parallel manner. Then, the determination apparatus 10 learns a model based on a result of the determination so that a result of the determination is closer to correct data (step S107), and the process ends.

5. Modifications

The determination apparatus 10 according to the embodiments described above may be carried out in various different modes in addition to the above embodiments. Thus, in the followings, other embodiments of the determination apparatus 10 described above will be described.

5-1. Processing Using Parameter

For example, the determination apparatus 10 described above generates the model in which association between a plurality of words are learned, using the cosine distance, the angle, and the dihedral angle between the plurality of words, as the parameters. However, embodiments are not limited thereto. That is, the determination apparatus 10 may use the cosine distance, the angle, and the dihedral angle between the plurality of words, as the parameters, to detect and output a word, a word group, or the like similar to a specified word or word group.

Furthermore, the determination apparatus 10 may specify the indices for adjusting the association between words in the learning data C10, that is, distributed representations of the words, in an arbitrary mode. For example, the determination apparatus 10 may provide a technique such as scoring using the TF-IDF, and may adjust the distributed representation on the basis of scoring by human. For the indices used to adjust such a distributed representation, an arbitrary publicly known technique can be applied.

5-2. Hardware Configuration

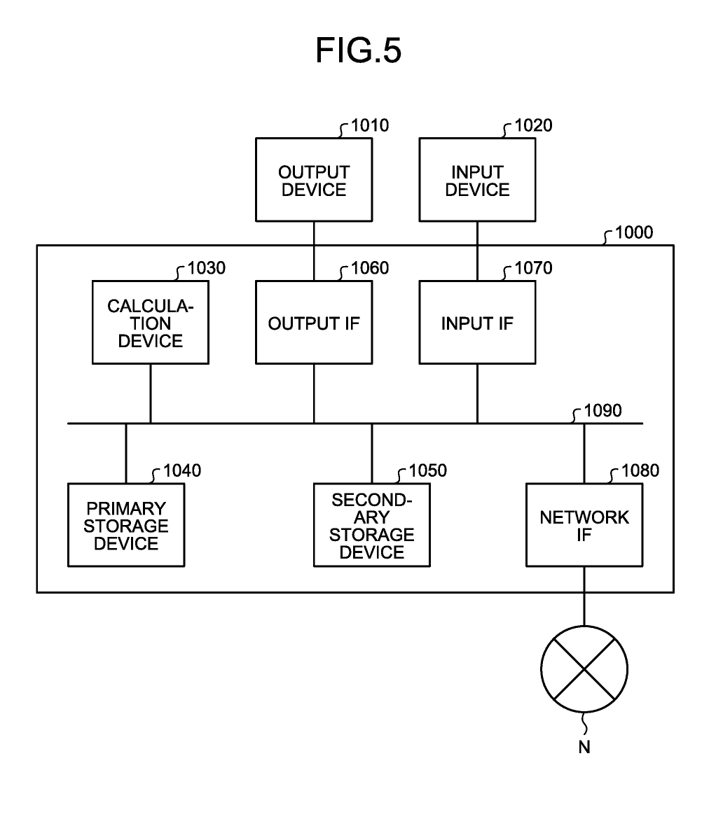

Furthermore, the determination apparatus 10 according to the embodiments described above includes for example a computer 1000 having a configuration as illustrated in FIG. 5. FIG. 5 is a diagram illustrating an exemplary hardware configuration. The computer 1000 is connected to an output device 1010 and an input device 1020, and has a configuration in which a calculation device 1030, a primary storage device 1040, a secondary storage device 1050, an output interface (IF) 1060, an input IF 1070, and a network IF 1080 are connected by a bus 1090.

The calculation device 1030 is operated on the basis of a program stored in the primary storage device 1040 or the secondary storage device 1050, a program read from the input device 1020, or the like to perform various processing. The primary storage device 1040 is a memory device, such as a RAM, temporarily storing data used for various calculations by the calculation device 1030. Furthermore, the secondary storage device 1050 is a storage device registering data used for various calculations by the calculation device 1030, or various databases, and includes a read only memory (ROM), HDD, a flash memory, or the like.

The output IF 1060 is an interface for transmitting information to be output to the output device 1010 outputting various sets of information, such as a monitor or a printer, and includes for example a connector in conformity with a standard such as universal serial bus (USB), digital visual interface (DVI), or high definition multimedia interface (HDMI) (registered trademark). Furthermore, the input IF 1070 is an interface for receiving information from various input devices 1020 such as a mouse, a keyboard, or a scanner, and includes for example a USB.

Note that the input device 1020 may be for example a device reading information from an optical recording medium such as a compact disc (CD), a digital versatile disc (DVD), or a phase change rewritable disk (PD), a magneto-optical recording medium such as a magneto-optical disk (MO), a tape medium, a magnetic recording medium, or a semiconductor memory. Furthermore, the input device 1020 may be an external storage medium such as a USB flash drive.

The network IF 1080 receives data from another device through the network N, transmits the data to the calculation device 1030, and transmits data generated by the calculation device 1030 to another device through the network N.

The calculation device 1030 controls the output device 1010 or the input device 1020 through the output IF 1060 or the input IF 1070. For example, the calculation device 1030 loads a program from the input device 1020 or the secondary storage device 1050 into the primary storage device 1040, and executes the loaded program.

For example, when the computer 1000 functions as the determination apparatus 10, the calculation device 1030 of the computer 1000 executes a program loaded into the primary storage device 1040 to achieve the function of the control unit 40.

6. Effects

As described above, the determination apparatus 10 associates three words between which association is to be determined, on the distributed representation space, and determines the association between the three words, as the angle defined by the three words associated with each other on the distributed representation space. More specifically, the determination apparatus 10 determines the association between the three words, by selecting one word from the three words associated with each other on the distributed representation space, and using the angle between the other two words about the one word as the vertex. As described above, the determination apparatus 10 can learn or use the association between three or more words converted to the angle on the distributed representation space, and the accuracy in natural language processing can be improved.

Furthermore, the determination apparatus 10 associates four words between which association is to be determined, on the distributed representation space, and determines the association between the four words, as the dihedral angle defined by the four words associated with each other on the distributed representation space. More specifically, the determination apparatus 10 determines the association between the four words, as the angle between two planes having a line, as the intersection line, including any two reference words of the four words associated with each other on the distributed representation space, and respectively including different words other than the reference words. As described above, the determination apparatus 10 can learn or use the association between four or more words converted to the angle on the distributed representation space, and the accuracy in natural language processing can be improved.

Furthermore, the determination apparatus 10 determines the association between any three words of four words, as the angle defined by the three words associated with each other on the distributed representation space. Thus, the determination apparatus 10 can further improve the accuracy in natural language processing.

Furthermore, the determination apparatus 10 determines association between arbitrary two words of a plurality of words between which association is to be determined, as the cosine distance between the two words associated with each other on the distributed representation space. Thus, the determination apparatus 10 can further improve the accuracy in natural language processing.

Furthermore, the determination apparatus 10 uses a result of the determination to cause the learner determining the association between a plurality of words to perform learning. For example, the determination apparatus 10 causes a neural network having a plurality of intermediate layers to perform learning. Thus, for example, the determination apparatus 10 can learn the distributed representation space, in consideration of the association between three or four or more words, and the accuracy in natural language processing can be further improved.

Furthermore, “unit” described above can be read as “means”, “circuit”, or the like. For example, a determination unit can be read as determination means or a determination circuit.

According to one aspect of an embodiment, accuracy in natural language processing can be improved.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A determination apparatus comprising:
an association unit that associates three words between which association is to be determined, on a distributed representation space; and
a determination unit that determines association between the three words as an angle defined by the three words associated with each other on the distributed representation space.

2. The determination apparatus according to claim 1, wherein
the determination unit determines the association between three words by selecting one word from the three words associated with each other on the distributed representation space, and using an angle between the other two words about the one word as the vertex.

3. A determination apparatus comprising:
an association unit that associates four words between which association is to be determined, on a distributed representation space; and
a determination unit that determines association between the four words as a dihedral angle defined by the four words associated with each other on the distributed representation space.

4. The determination apparatus according to claim 3, wherein
the determination unit determines association between the four words as an angle between two planes having a line, as an intersection line, including any two reference words of the four words associated with each other on the distributed representation space, and respectively including different words other than the reference words.

5. The determination apparatus according to claim 3, wherein
the determination unit further determines association between three words of the four words, as an angle defined by the three words associated with each other on the distributed representation space.

6. The determination apparatus according to claim 1, wherein
the determination unit further determines association between arbitrary two words of a plurality of words between which association is to be determined, as a cosine distance between the two words associated with each other on the distributed representation space.

7. The determination apparatus according to claim 1, further comprising:
a learning unit that causes a learner determining association between a plurality of words to perform learning by using a result of determination by the determination unit.

8. The determination apparatus according to claim 7, wherein
the learning unit causes a neural network having a plurality of intermediate layers as the learner.

9. A determination method performed by a determination apparatus, the method comprising:
associating three words between which association is to be determined, on a distributed representation space; and
determining association between the three words as an angle defined by the three words associated with each other on the distributed representation space.
